(19) United States
(12) Patent Application Publication
(10) Pub. No.: US 2006/0228687 A1
(43) Pub. Date: Oct. 12, 2006

(54) Electronic learning environment

(75) Inventor: Ian Robert Gomersall, West Yorkshire (GB)

Correspondence Address: MERCHANT & GOULD PC, P.O. BOX 2903, MINNEAPOLIS, MN, 55402-0903, US

(73) Assignee: BTL Group Ltd, West Yorkshire (GB)

(21) Appl. No.: 11/204,845

(22) Filed: Aug. 15, 2005

(30) Foreign Application Priority Data
Apr. 9, 2005 (GB) 0507254.1

(51) Int. Cl. G09B 7/00

(52) U.S. Cl. 434/323

(57) ABSTRACT

Data processing methods, apparatus and user interfaces for providing an electronic interactive learning environment are described. A question which can be answered by a user is displayed. A user command can select to answer the question, to be guided through answering the question or to have the method of answering the question shown. If the user selects to answer the question directly, then answer data input by the user is received, including a final answer, and it is determined whether the final answer is correct and an indication whether the final answer is correct is displayed. If the user selects to be guided, then user answer data input by the user is received and it is determined whether current answer data for a current step of the method is correct and an indication whether the current answer data is correct is displayed. If the user selects to be shown the method of answering the question, then correct answer data is shown for each step in the method of answering the question.

### BACKGROUND OF THE INVENTION

1. Field of the Invention

The present invention relates to electronic learning, and in particular to a computer based system for providing electronic interactive learning to a user.

2. Description of the Related Art

Computer based tests are available which can generate questions, allow users to enter answers and provide scores letting a user know what questions they answered correctly and which questions they answered incorrectly. Some can also provide simple feedback to the user of a ‘show the answer’ nature. However, in such computer based learning systems, there is little scope for the user to interact with the system in order to actually learn and understand the question and answer. Rather, the systems simply provide marks or display answers and provides no guidance to actually help the user learn. The system simply acts as an automatic marking system.

In other computer based distance learning systems, a user can send answers to questions to a marker or tutor over a computer network. The tutor or marker can then mark the answers and provide feedback to try and help the user learn. However, such systems do not provide immediate feedback or guidance to a user and so the user can still find it difficult to learn while answering questions.

It would therefore be beneficial to be able to provide a computer based learning system which provides real time interaction with a user and which allows a user to control their learning based on their stage of learning and understanding.

### SUMMARY OF THE INVENTION

The present invention provides a question driven learning system, in which different types or learning routes are provided and the user can select which learning route to use.

According to a first aspect of the present invention, there is provided a computer implemented interactive learning method. The method can comprise displaying a question which can be answered by a user. A user command can be received selecting a manner in which to do the question. The user can then do the question in a number of different ways in which the amount of assistance provided to the user in answering the question varies depending on the manner of doing the question the user selected. The user can do the question by entering an answer, being guided through entering an answer, or have how to answer be explained.

Hence, the user can select the learning mode most appropriate to the user's current learning needs. Therefore the user can use the system, to learn how to do questions or to practice doing questions with guidance or simply to practice questions without guidance.

The learning approach is underpinned by the principle of the ‘learning loop’ in which learning is initiated by a question or problem. A theory is formulated (where the theory in its broadest sense includes an idea or a hypothesis as to how to answer the question or solve the problem), the theory is tested against the question or problem, the user reflects on the outcome of testing the hypothesis (did it solve the problem or get the question right, and if not why not), and then attempts a further question of the same, similar or different type. The invention provides a mechanism allowing a user a choice of routes around the learning loop, which may be selected according to the user's evolving learning needs.

The user can select to answer the question directly, to be guided through the steps of a method of answering the question or to have the steps of the method of answering the question shown to the user. This brings a choice normally made by a teacher under the control of the learner. Hence, a more interactive and tailored learning environment is provided.

If the user has selected to answer the question directly, then answer data input by the user including a final answer can be received. Whether the final answer corresponds to the correct answer to the question can be determined. An indication whether the final answer is correct can be displayed.

If the user has selected to be guided through the steps of the method of answering the question, then user answer data input by the user can be received. Whether current answer data for a current step of the method is correct can be determined. An indication whether the current answer data is correct can be displayed. The real time knowledge of the location of an error is important as it allows the learner to focus effort on the critical point and reduce redundant effort in repeating correct work in order to try and locate the error. In the absence of an explanation at that point, the learner is able to devote maximum effort to resolving the cognitive conflict that arises.

If the user has selected to have the steps of the method of answering the question shown, then, for steps in the method of answering the question, current answer data can be shown illustrating the correct answer and/or method for the steps of the method of answering the question.

The question can be displayed in a user interface. The user interface can comprise a question display portion in which the question is displayed. The user interface can comprise a control section or sections including a control element or elements. The control element or elements can be activated to select the manner in which the question is to be done. The control element or elements can be provided in the question display portion of the user interface. The control element or elements can be used to select trying to answer the question directly and/or to be guided through answering the question and/or being shown steps of the method of answering the question.

A control element can be provided to display some or all of the steps of the correct method or methods for answering a question at any step of the question.

The user interface can include a further control element or elements which can be activated to display an indication whether answer data is correct. The user interface can includes a further control element or elements which can be activated to display the correct answer.

The steps in the method of answering the question can be displayed by calling a sequence of scenes. The next scene to display in the sequence can be determined by a user input. The user input can be received from a control element or from a user interface component or element of the display portion of the user interface.

Each scene can be created or rendered from data items in a file specifying the content of the scene and/or the appearance of the scene. The data items can also specify how at least some of the scenes are linked together.

The file can include a mark up language defining part of the content of the scene and/or appearance of the scene. The file can also include a media file or a plurality of media files to be used as a part of the scene. The or each media file can be a graphics file or a sound file.

According to a further aspect of the invention, there is provided a method for authoring interactive questions to be used by a user in an interactive electronic learning environment. Data items specifying the content and appearance of a plurality of scenes for an interactive question can be generated. Each scene can display or correspond to a step in a method of answering the question. Data items specifying which scene to display next in a sequence of scenes dependent on user input can also be generated.

A viewing engine can also be associated with the file for displaying a sequence of scenes to the user. The specific sequence of scenes displayed can depend on the user input.

The data items cam include mark up language instructions defining the content and/or appearance of each scene and/or a media file to be used in the scene.

The data items and/or reading engine can be provided in a file. The file can further include a reading engine for reading the data items to generate the scenes to be displayed from the data items. The file can also include a navigation engine which controls what scene to display next based on user input. The file can be written to or stored on a computer readable medium.

According to a further aspect of the invention, there is provided a method for providing an electronic interactive learning environment allowing a user to select how to do a plurality of questions. Data items specifying the content and appearance of a plurality of scenes for each of a plurality of interactive questions can be read. At least some of the scenes can display a step in a method of answering the question. The data items can also specify which scene to display next in a sequence of scenes dependent on user input. A scene for a currently selected question can be displayed. User input selecting a manner in which to do the currently selected question can be received. A sequence of scenes for the question can be displayed. The sequence of scenes can allow the user to do the question in the manner selected by the user.

According to a further aspect of the invention, there is provided a user interface for an interactive electronic learning environment. The user interface can include a question display portion for displaying a plurality of scenes relating to questions and steps of methods of answering questions. The user interface can include a control element or elements selectable by a user to select a manner of how to do a questions.

A first control element can be selectable by a user to answer a displayed question directly. A second control element can be selectable by a user to be guided through at least some of the steps of a method of answering a displayed question. A third control element can be selectable by a user to be shown at least some of the correct steps of a method of answering a displayed question.

According to a further aspect of the invention, there is provided a data processing apparatus for providing an interactive electronic learning environment including a plurality of questions which can be displayed to a user and used by the user to interactively learn. The apparatus can comprise a data processor configured by computer program code. The computer program code can configure the data processor to: display a question which can be answered by a user; receive a user command selecting a manner in which to do the question. The user command can select to answer the question directly, to be guided through at least some of the steps of a method of answering the question or to have at least some of the steps of the method of answering the question shown to the user.

The computer code can also configure the data processor to cause one, some or all of the steps of a correct method or methods of answering the question optionally to be displayed to a user.

If the user selects to answer the question directly, then the computer code can configure the processor to receive answer data input by the user including a final answer, determine whether the final answer corresponds to the correct answer to the question and display an indication whether the final answer is correct.

If the user selects to be guided through the steps of the method of answering the question, then the computer code can configure the processor to receive user answer data input by the user, determine whether current answer data for a current step of the method is correct and display an indication whether the current answer data is correct.

If the user selects to have the steps of the method of answering the question shown, then the computer code can configure the processor to, for at least some of the steps in the method of answering the question, display current answer data illustrating the correct answer for the steps of the method of answering the question.

According to a further aspect of the invention, there is provided a data processing apparatus for authoring interactive questions to be used by a user in an interactive electronic learning environment. The apparatus can include a data processor configured by computer program code to: create data items specifying the content and appearance of a plurality of scenes for an interactive question, each scene displaying a step in a method of answering the question, and data items specifying which scene to display next in a sequence of scenes dependent on user input.

The computer program code can also configure the data processor to provide a viewing engine associated with the file for displaying a sequence of scenes to the user, wherein the specific sequence of scenes displayed depends on the user input.

According to a further aspect of the invention, there is provided an electronic interactive learning product comprising a computer readable medium bearing computer program code executable by a data processor. The computer program code can include instructions and data specifying the content and appearance of a plurality of scenes for an interactive question. Each scene can display a step in a method of answering the question. The instructions and data can also specify which scene to display next in a sequence of scenes dependent on user input.

The product can further comprise instructions providing a viewing engine for creating a user interface. The user interface can include a question display portion in which the scenes can be displayed to a user and/or at least a first control element or elements allowing the user to select a manner in which to do the question. Control elements can be provided in the question display portion of the user interface or in a control portion. Control elements can also be provided which can receive user input used to determine which scene to display next.

According to a further aspect of the invention, there is provided computer program code executable by a data processing device to provide any of the method, user interface or apparatus aspects of the invention. A computer program product comprising a computer readable medium bearing such computer program code is also provided as an aspect of the invention.

### BRIEF DESCRIPTION OF THE DRAWINGS

An embodiment of the invention will now be described, by way of example only, and with reference to the accompanying drawings, in which:

FIG. 1 shows a high level flow chart illustrating the creation of learning content according to the invention and the user of that learning content according to the invention;

FIG. 2 shows a process flow chart illustrating a process for authoring interactive learning content according to the invention;

FIG. 3 shows a schematic block diagram illustrating the software architecture of an interactive learning computer program product according to the invention and created by the authoring process illustrated in FIG. 2;

FIG. 4 shows a schematic block diagram of a computer system according to the invention for authoring the product illustrated in FIG. 3 using the method illustrated in FIG. 2;

FIG. 5 shows a process flow chart illustrating a process for authoring interactive learning content in greater detail;

FIG. 6 shows a process flow chart illustrating a process for sending authored content to store;

FIG. 7 shows a process flow chart illustrating a process for storing authored content;

FIG. 8 shows a process flow chart illustrating a process for publishing an interactive learning product;

FIG. 9 shows a process flow chart illustrating a process for providing interactive learning to a user according to the invention;

FIG. 10 shows a flow chart illustrating an interactive learning method according to the invention;

FIG. 11 shows a screen shot illustrating the user interface of the interactive learning application and a first example question;

FIG. 12 shows a screen shot illustrating the user interface of the interactive learning application and a second example question;

FIG. 13 shows a screen shot illustrating the user interface of the interactive learning application and a third example question;

FIG. 14 shows a screen shot illustrating the user interface of the interactive learning application and a fourth example question; and

FIG. 15 shows a schematic block diagram of a data processing apparatus which can be used to provide the invention.

Similar items in different Figures share common reference numerals unless indicated otherwise.

### DETAILED DESCRIPTION OF THE INVENTION

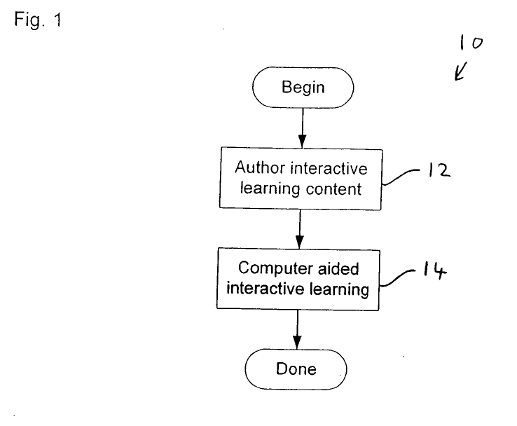

With reference to FIG. 1 there is shown a flowchart illustrating, at a high level, a method of providing an electronic interactive learning environment which can be used by a user in order to do questions in a manner most appropriate to the user's current learning requirements and development. Before the user can use the electronic interactive learning environment, content for the learning environment, that is interactive questions, are created at step 12. The data processing processes and data processing apparatus involved in the authoring of interactive learning content will be described in greater detail below. After the content has been created, then at step 14 the user can learn, or teach themselves, using the interactive learning environment on a computer. Again, the data processing methods and data processing apparatus involved in the electronic interactive learning method will be described in greater detail below.

The embodiment to be described relates to the subject area of mathematics and includes four questions only. However, it will be appreciated that greater or fewer questions can be included. It will also be appreciated that the subject matter of the learning content is not limited to mathematics. Rather, the invention is applicable to learning in all subject matter areas in which a user will benefit from having the opportunity to do questions relating to the subject matter area and having the facility to be guided through or shown the answers to the questions as required.

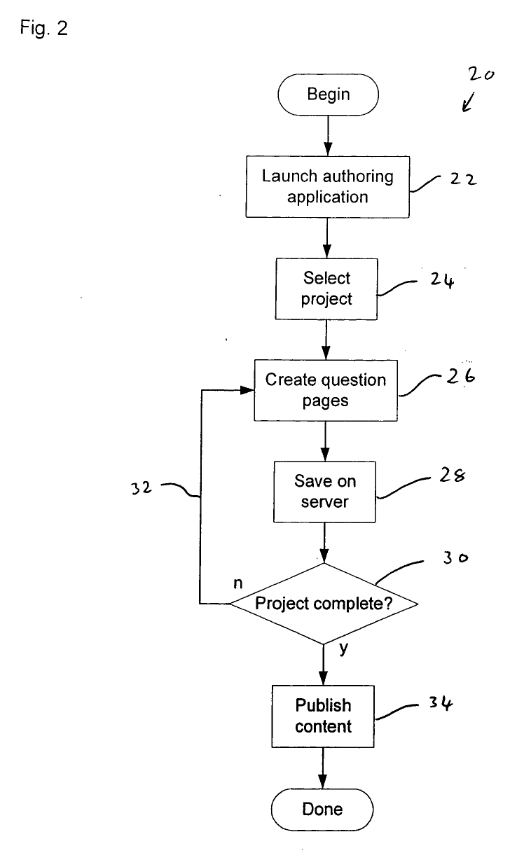

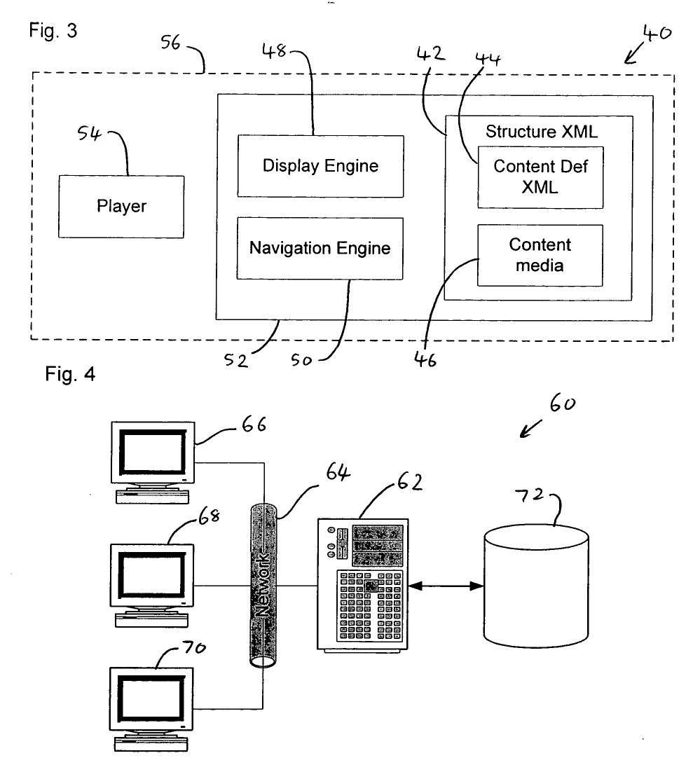

With reference to FIG. 2, there is shown a process flowchart illustrating a process 20 for creating or authoring interactive learning content for use in the interactive learning environment. FIG. 3 shows a schematic block diagram of the architecture of an interactive learning product 40 as created by the author in process 20 and FIG. 4 shows a schematic block diagram of an interactive learning product authoring computer system 60 which can be used to create interactive learning product 40 according to authoring process 20.

The authoring computer system 60 includes a central server, or servers, 62 which includes a database application providing database services and a web server application providing network communication services. The server 62 is in communication with a database 72 which stores authored content and content being developed. In one embodiment, the database can be a SQL database and the database application can be a SQL server application. The web services application run on an Internet Information Server (IIS) application, as provided by Microsoft Corporation.

The server 62 is connected to a network 64, which can be an internet network, to which a plurality of authoring stations 66, 68, 70 are attached. Each authoring station 66, 68, 70 includes an authoring application which is used to create the interactive learning content. In one embodiment, the authoring application is a visual builder tool application which allows a user to build scenes via a user interface into which the user can drop pre-defined objects or entities or create objects or entities to be displayed in the scene. The authoring application can also display an XML file corresponding to the content being visually built, which can be edited by the author. The authoring application can also be used to introduce other media content into the scenes being built. For example image files or sound files or interactive graphics can be incorporated into the scenes.

Returning to FIG. 2, at step 22 the author launches the authoring application on their authoring computer which connects to server 62 over network 64. Then at step 24, the author either selects a current project, that is a collection of questions, to either begin authoring or to continue authoring. If the author selects to create a new project, then an XML project file is created by server 62 in database 72. Alternatively if the author selects to continue working on a current project then the author can select which question from the project to either create or continue authoring and the relevant data is retrieved by server 62 from database 72 and downloaded to the author computer.

Then at step 26, the author can select to either create a new question or edit a previously created question.

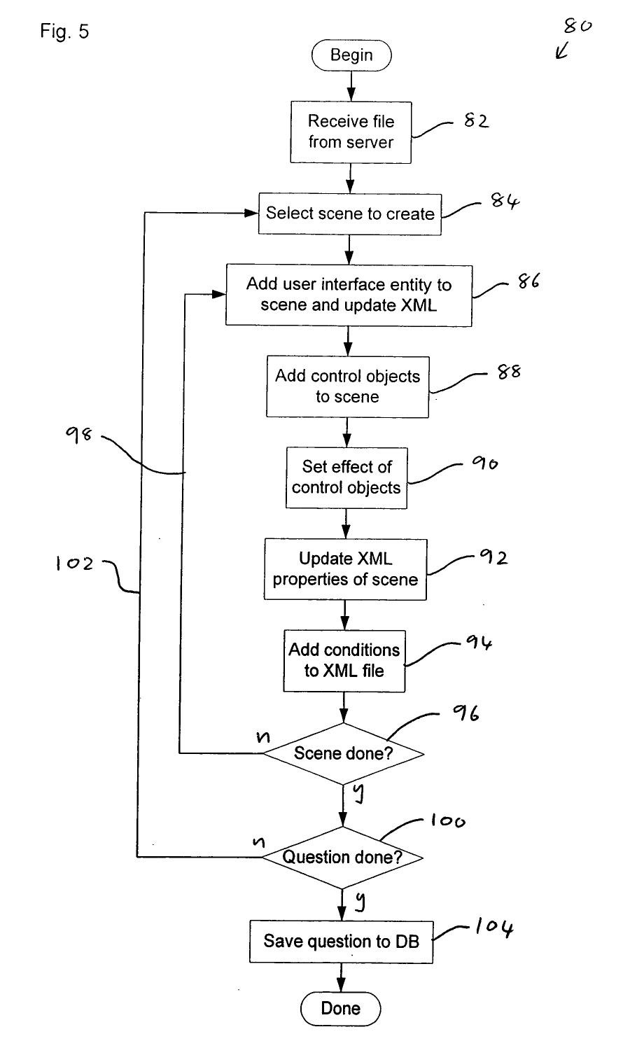

FIG. 5 shows a flowchart illustrating a question authoring process 80, corresponding generally to step 26, in greater detail. At step 82, the authoring client computer receives an XML file, and any existing related media, for the question over the network from the web services application. Each question is comprised of a plurality of scenes which are displayed in various sequences, depending on how the user selects to do the question. So any one question, or page, in the project has multiple scenes displaying different information to the end user.

At step 84, the author selects the scene to be created. Then at step 86, any user interface entities required for the scene currently being authored are selected and added to the scene. Using visual builder tools playable in the authoring application, the author can select, for example, a text box, place the text box in the scene, define the size and appearance of the text box and enter text to be displayed, such as the text of a question. The author can also select and add any other user interface entries, such as an answer box, multiple choice fields, drop down lists, a gap fill box and any graphical elements or content to the scene currently being authored. As each user interface entity is added to the scene, an XML file for the scene comprising XML code corresponding to the user interface entities is updated. The author can also manually edit the XML to specify the content, appearance or format of any of the user interface entities present in the scene. The user can also add any other media content associated with the scene, such as graphics files to be displayed or played with the scene. The authoring application also includes a viewer which can run in a player, such as a Macromedia Flash Player, which can be used to preview the scene so that the author can check that the scene has the correct appearance.

The XML code for the scene can include various data items, including data items identifying the type of the user interface entity, the position of the user interface entity and various properties and attributes of the user interface entity, including any text or other content of the user interface entity. The XML file is constantly updated as user interface entities are added to, removed from, or edited in the current scene.

Active, or controlled entities can also be added to the scene. These entities, sometimes referred to as buttons, can be used to control a next action to be carried out when the control entity is selected by a user. At step 88 any control objects can be added to the scene. Then at step 90, the effect of activating any of the control objects is specified and at step 92 the XML file is updated to reflect the intended effect of any control objects. For example the effect of a control object can be to go to a next scene in the question, raise an event, go to a different page or question or can be a custom function which can be specified by the author.

Some of those dialogue boxes via which a user can input answer data can also have an event associated with input of answer data.

At step 94, the XML file can be edited to add certain conditions specifying the actions to carry out on a particular event occurring. The conditions can include a number of data items. An event source data item can identify the control object with which the event is associated. A source data item can specify the location of the control object, that is whether the control object is associated with the current scene or with a different scene. A source ID data item identifies the scene with which the source is associated. A check condition data item specifies what property is to be determined on activating the control object, e.g. whether an answer is correct or wrong. An action data item specifies the action to be carried out, such as to reveal whether the answer is correct or wrong. The action data item can specify other actions, such as providing inline display of a hint or other feedback, going to a different scene, revealing information, or carrying out a validation process to check whether an action has been completed. A target type data item can also be provided which specifies where next to proceed to. A target ID data item can also be provide to specify the scene or page to go to.

Hence, using the condition data items, if the question has a multiple choice answer and if the first answer is correct but the user selects the second answer, then the condition data items can be used to point to a next scene which displays both that the answer is incorrect and provides an on-screen explanation as to why the answer is incorrect.

Authoring of the scene is an iterative process, as illustrated by decision box 96 and processing return loop 98 illustrating that at any stage during authoring of the scene, the author can select to edit the scene either using visual tools or editing the XML so as to change the content of the scene and the control conditions relating to the scene.

When it is determined that the current scene has been completed then processing proceeds to step 100 at which it can be determined whether the question has been completed. Any one question comprises a plurality of scenes and wherein different sequences of scenes are displayed, depending on the user inputs received during answering any question. If the question has not yet been completed the processing returns to step 84, as illustrated by processing loop 102 and the author can select a next scene to create. When the author has completed all the scenes required for a question then processing proceeds to step 104 and the question data can be saved on database 72.

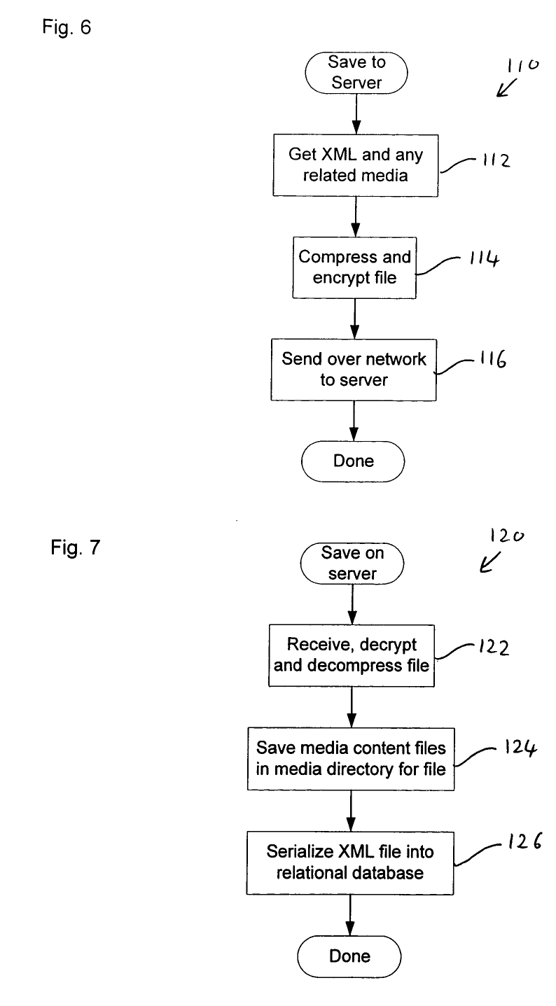

FIG. 6 shows a process flowchart illustrating a question saving process 110 carried out by the authoring application. At step 112, for the current page, the XML code and any related media content, such as graphics files for any of the scenes in the page are assembled. At step 114 the XML and any media files are compressed, for example by being zipped into a zip file, and encrypted. Then at step 116 the encrypt and compressed file is sent over network 64 to server 62. The authoring process for the current page is then completed.

Returning to FIG. 2, at step 28, the page is saved on the server using a page saving process illustrated by the process flowchart shown in FIG. 7. On receiving the data for the page, the web services application of server 62 decrypts and decompresses the received file at step 122. The XML file is then passed to the database application. Any media files in the scenes of the current page are saved in a media directory for the current page at step 124. Then at step 126, the data in the XML file is serialised and written into various tables in relational database 72.

Database includes a table for each different type of object that can be present in any scene and also a scene table storing data items relating to each individual scene, a page table storing data items relating to each individual page and a structure table storing data items specifying the structure of any individual project or group of questions. For example the database includes a text box table having a number of fields for storing various data items relating to any text box and wherein the table includes a record for each text box present in any of the scenes for all pages in a single project. Hence, there is a separate row for each table object and a separate field for any property of any table object. By providing separate tables for each different type of entity or object in the scenes and a separate record for each object or entity in any of the scenes, it is easier to update or modify an individual object or entity, rather than having to modify the entire scene or all the scenes in a question. A separate database is provided for each project.

Returning to FIG. 2, at step 30 it is determined whether the project is complete, that is whether all the questions required for the current project or interactive learning project have been authored. If not, then the method returns to step 26, as illustrated by loop 32, and further questions can be authored. When all the questions have been authored, then processing proceeds to step 34 at which the selection of questions or project can be published or otherwise made available to a user.

The electronic interactive learning product can be published in a number of formats. In one embodiment, the interactive electronic learning product is published to a computer readable medium, such as a CD-Rom so that it can be distributed to individual users.

FIG. 3 shows a schematic representation of the software architecture of the electronic interactive learning product 40. The interactive learning product includes a number of components in order to provide the interactive learning environment for a user. The product includes the data 42 specifying the content of the pages of the product. As explained above, the content of the questions is defined by XML data 44 and media data 46 for any media content associated with any of the scenes or pages. Data and instructions specifying a display engine 48 are also included. The display engine handles the generation and display of scenes based on the XML and media data. Data and instructions specifying a navigation engine 50 are also included. Navigation engine 50 helps to control the sequence of scenes and the sequence of questions displayed, dependent on user input. Some control of the sequence of scenes and pages can also be provided by display engine 48, again dependent on user inputs. If published to a single computer readable medium, then the electronic interactive learning product 56 also includes a player, or viewer application 54 for actually displaying the interactive learning environment 52, comprising the display engine 48, navigation engine 50 and content 42.

In one embodiment, the player can be a flash player, as provided by Macromedia Inc, and the display engine and navigation engine can be in Flash file formats. Hence, an end user can load the published CD-Rom 56 including the interactive learning product and the interactive learning environment is provided as a flash movie displayed by player 54 reading the display engine and navigation engine files to control the sequence of display of the various scenes of each question based on the interactive user input during answering questions.

In an alternate embodiment, all the components of the electronic interactive learning product are not published together in a single bundle. Instead, the electronic interactive learning product 52 can be made available on a website and a user can download the product 52 and display the interactive learning environment using a player 54.

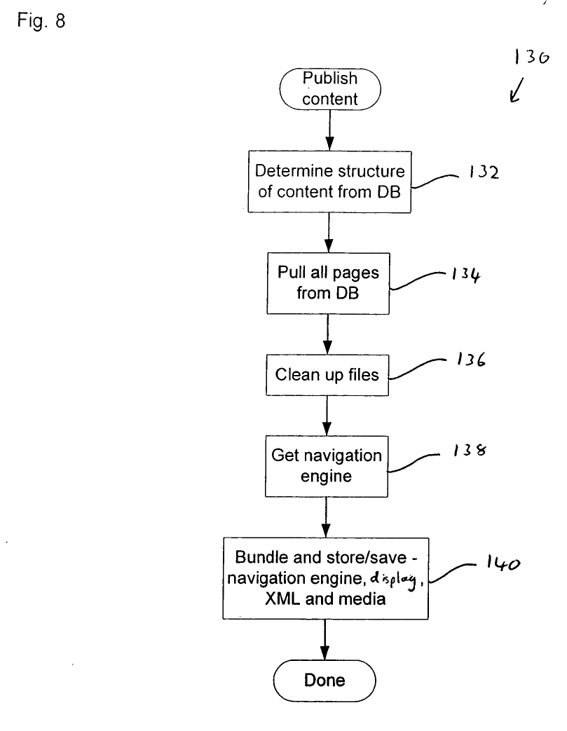

FIG. 8 shows a flowchart illustrating a publication process 130, corresponding generally to step 34 of FIG. 2, in greater detail.

A publishing application resident on server 62 can be used to carry out the publication process 130. At step 132, the structure of the project or learning content is determined from the structure table of the database which specifies which pages are included in the project or content. Then at step 134, the XML data and any media files required for each of the scenes for all of the questions in the project are retrieved from the various tables in database 72. Then at step 136, any unwanted or unneeded data is removed from the files for optimisation.

Then at step 138 a navigation engine, specific to the content is obtained. The navigation engine is developed separately by a software developer and associated with the project once the project is complete. As will be described in greater detail below, the navigation engine helps to control the sequence of display of questions and scenes within any question, dependent on user inputs. Then at step 140, the XML and media data specifying the content, the navigation engine and a display engine for rendering the content are bundled together and saved together with a copy of the player application, if required. The resulting files 56 are then recorded on a computer readable medium for example by being burnt to a CD-Rom. In an alternative embodiment, as discussed above, the navigation engine, display engine, XML content and any media files can be bundled and saved on a web server for remote access using HTTP over the Internet.

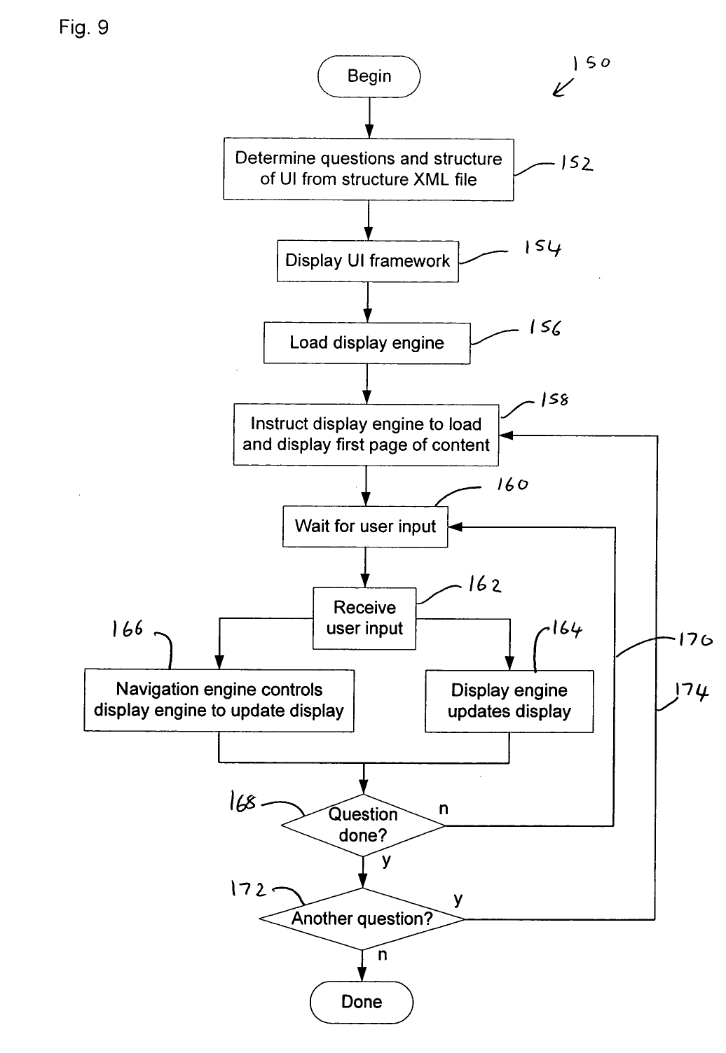

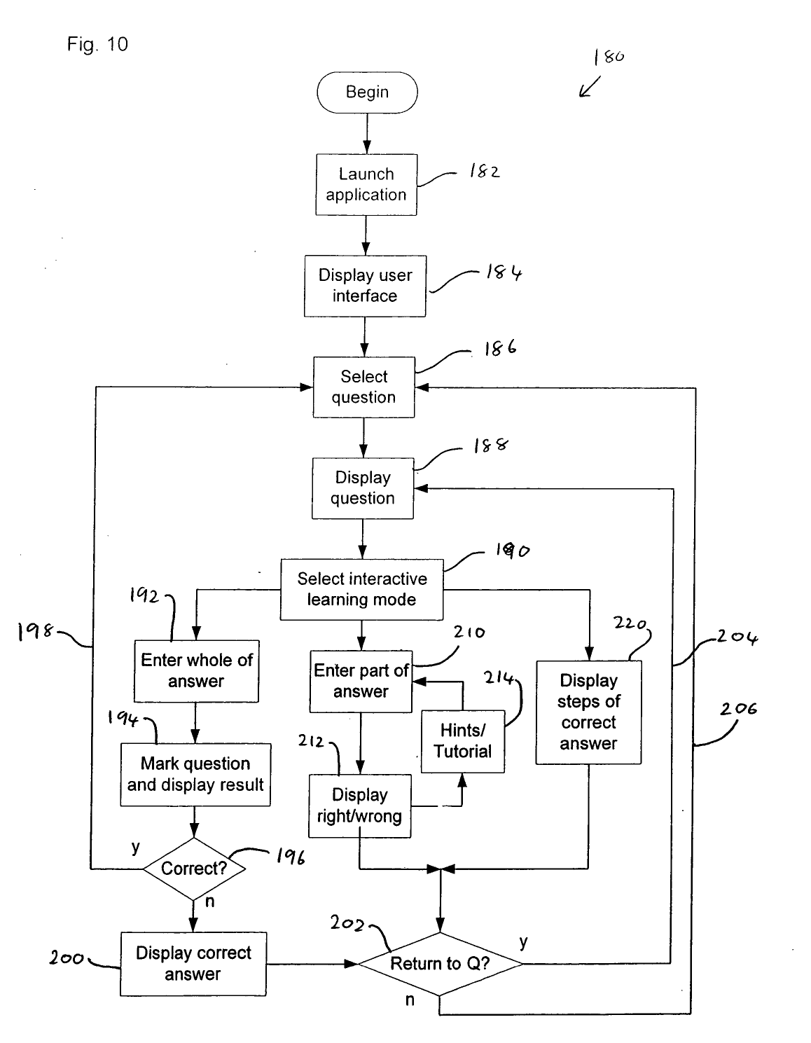

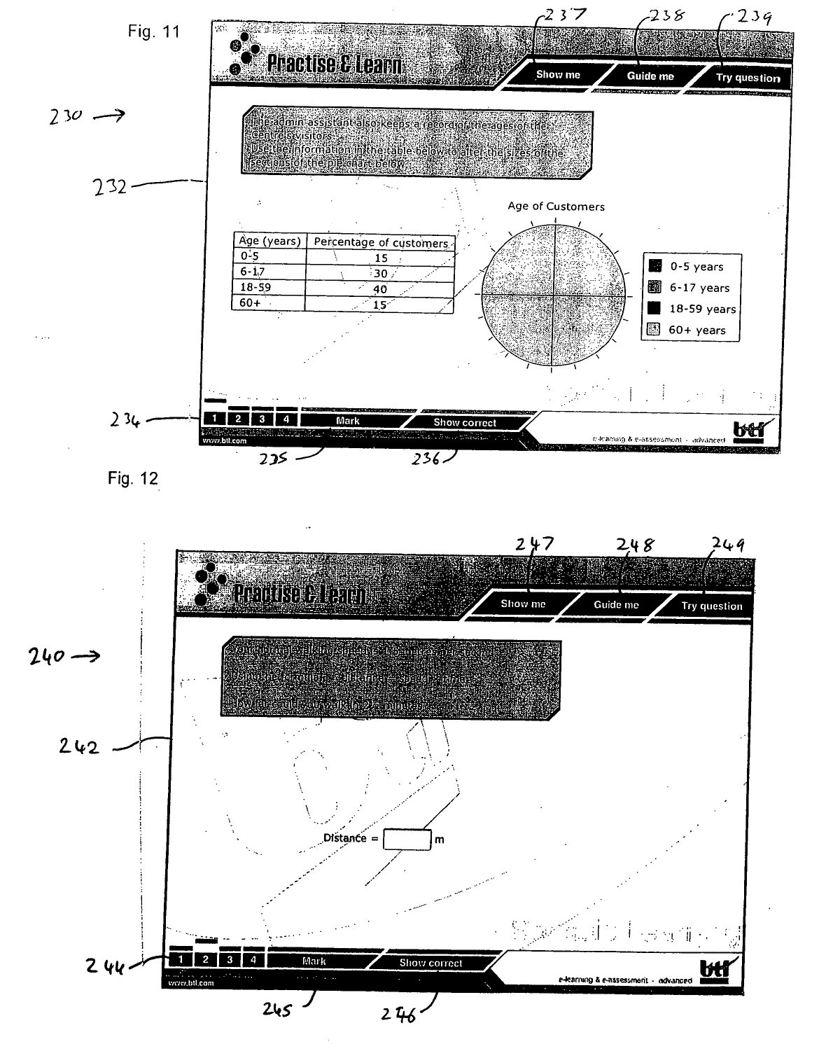

FIG. 9 shows a process flow diagram of a process 150 for controlling an interactive learning environment according to the present invention. FIG. 10 shows a flowchart illustrating a method 180 of interaction of a user with the interactive learning environment and FIGS. 11 to 14 each show a screen shot of the user interface 230, 240, 250, 260 of different questions in a “try question” mode of the interactive learning environment according to the invention.

Each user interface 230, 240, 250, 260 includes a question display portion 232, 242, 252, 262 in which question information and user interface entities via which the user can input data are displayed. Each user interface also includes a number of control elements or buttons activatable by the user to control their manner of interaction with the learning environment. Four question selection buttons 234, 244, 254, 264 are provided outside of the display portion and can be activated by the user to select a question to display. Buttons 257, 258 and 259 provide control elements which can be activated to select a “show me”, “guide me” or “try question” learning mode respectively.

The try question button 239, 249, 259, 269 is actionable to allow the user to directly input the answer to the question, without guidance from the learning environment. In the “try question” learning mode illustrated, a mark button 235, 245, 255, 265 is provided which is activatable to request that the answer to a question be marked to indicate whether the answer is correct or incorrect. A show correct button 236, 246, 256, 266 is also provided which is activatable to cause the correct answer to a question to be displayed to the user.

The “show me” button 257 is activatable to cause the interactive learning environment to enter a “show me” mode at any stage during a question, in which each of the steps in a model answer to the question is shown, explaining the method by which the question can be answered. In the “show me” mode, button 235, 245, 355 and 265 is omitted and button 236, 246, 256 and 266 is replaced with a “next” button, which when activated causes the next step in the model answer to the question to be displayed to the user.

The “guide me” button 238, 248, 258, 268 is actionable to cause the interactive learning environment to enter a “show me” mode at any stage during a question. In the “guide me” learning mode the interactive learning environment displays each of the steps in a method of answering the question and provides feedback and guidance on whether the user has completed each of the steps correctly or not. Button 236, 246, 256 and 266 is provided as a “next” button, which when activated causes the guide me material to progress to the next stage or step. Ticks or crosses are shown automatically and update as the answers are entered and/or edited by the user. As the user progresses through the question, the correct answer to previous steps or stages are shown. In the “show me” mode, button 235, 245, 355 and 265 is provided as a “hints” button so that when it is activated a hint or other guidance or teaching material relevant to the current step or stage of the question is displayed to the user to guide them through answering the question.

The underlying data processing operations involved in providing the interactive learning environment will now be described with reference to FIG. 9, prior to describing use of the interactive learning environment with reference to FIG. 10.

As illustrated in FIG. 9, on launching the interactive learning environment application, the navigation engine 50 reads a structure XML file to determine the appearance and format of the user interface. The structure XML file is created by the authoring application as pages are added or removed from the project structure. This file is included during the packaging process described above. The navigation engine can determine the general structure of the interactive content, that is how many questions are available to a user, which in the described embodiment is four. The structure file also provides details of any background graphics or the appearance of any buttons in the user interface which are not part of the question display portion. The navigation engine loads the display engine and at step 154, the navigation engine controls the display engine 48 to render and display the structure of the user interface to the user.

At step 158, the navigation engine instructs the display engine to load and display the first page of content in the display portion of the user interface. The display engine reads the XML data and any media files associated with the first page and renders and displays appropriate images in the display portion of the user interface. The interactive learning environment then awaits any user input at step 160.

At step 162 user input is received, either by way of selection of a control element in the user interface or data being entered as part of an answer to a question. Depending on the nature of the user input, either the display engine itself updates the display at step 164, or at step 166 the navigation engines calls the display engine to update the display, responsive to the user input. For example, if the mark button is activated, then the display engine calls a mark answer method or routine which determines whether the entered answer is correct or not. If the answer is correct then a tick is displayed adjacent the answer and if the answer is incorrect then a cross is displayed adjacent the answer. If the show correct button is activated then the display engine calls a show correct method or routine and looks up the correct answer to the question in the associated XML data and displays the correct answer to the question in the display portion of the user interface.

In an alternate embodiment, the navigation engine can handle activation of the mark or show correct buttons and call a mark question method or show correct answer method as defined by an interface between the navigation engine and display engine.

If the show me, guide me, or try question buttons are activated, then the navigation engine handles these control elements and determines which scene for the current question should next be displayed. The navigation engine tells the display engine which scene next to display and the display engine retrieves the appropriate XML data and any associated media files and updates the display portion of the user interface. In an alternate embodiment, any of the show me, guide me and try question buttons can be provided as control elements or buttons within the question display portion and activation of any of these buttons can be handled by the display engine. The display engine can call a get scene function or method passing in a parameter identifying the first scene required in the show me, guide me or try question modes of interaction. However, in the preferred embodiment, the navigation engine determines the initial scene of a sequence of scenes for any question and then the next scene to display in the sequence is generally determined by user input within the display portion.

If the question has not yet been completed, for example if the user does not elect to simply try the question, then at step 168 control returns to step 160, as illustrated by processing loop 170. Further if user input is awaited then at step 162 the received user input is acted upon either by the navigation engine or display engine at steps 166 or 164 in order to update the display to reflect the progress of the question. Processing continues to loop until the current question has been completed. Processing then proceeds to step 172 at which the user can select to do another question. If the user does select to do another question, for example by selecting any of the question selection buttons, then processing returns to step 158, as illustrated by processing loop 174, and the display engine loads the first scene for the selected question. Processing then continues as described above for this new question. The user can then continue answering questions until all questions have been answered, or the user otherwise decides to stop, and processing can then terminate.

Use of the interactive learning environment by a user will now be described with reference to FIG. 10 and FIGS. 11 to 14.

After the interactive learning application has been launched at step 182, the user interface of the interactive learning environment is displayed to the user at step 184. At step 186, the user can select a question to be displayed by either operating one of the question selection buttons or alternatively a default first question can be selected. At step 188 the display engine displays the selected question to the user in the display portion of the user interface.

For example, FIG. 11 shows a graphical question being displayed in the user interface 230. A text box explains the question to a user. A table presents information required by the user in order to answer the question and a graphical representation of a chart is presented with which the user can interact to input an answer to the question, by moving the radii in order to select the sizes of the different parts of the pie chart to reflect the required percentages in order to answer the question. At step 190, the user can determine which interactive learning mode they want to use in order to learn. If the try question option is selected, by activating the try question button 239, then processing proceeds to step 192. The user can use a pointing device, such as a mouse, to move the radii until the pie chart is considered to reflect the correct answer to the question. The user then activates the mark button 235 and if the user's answer is correct a tick is displayed for each correct segment of the pie chart. Any segments that are incorrect are highlighted by placing a cross over those segments. If the user has got the question correct, then at step 196 the user can proceed to select a different question, as illustrated by line 198 by activating a select question button. If the user has not got the answer incorrect, then at step 200, the show correct button can be activated and the display is updated to show the correct answer, which in this case is the pie chart with the segments having the correct areas. After the correct answer has been displayed, processing can proceed to step 202. The user may decide to try the question again in which case processing proceeds to step 188 and the user can select which learning mode to use in doing the question. If the user decides that they do not wish to re-do the question, then processing can proceed to step 186, as illustrated by line 206, and the user can select a different question.

If at step 190, the guide me button 238 is activated, then the user is led through the different steps of the correct way of answering the question using the next button and guidance is provided at each step to help the user complete each step correctly. A next scene is displayed in which the user can move any of the radii as part of answering the question at step 210. At step 212, when the user has moved the radii, then it is determined which of the segments, if any, are correct and the scene is updated to display a tick for those segments which are correct and a cross for those segments which are incorrect. Hence, optionally at step 214, visual hints can be provided to the user by the user activating the hints button to show which parts of the answer they have got right. Processing then returns to step 210 at which the user can update their answer and processing continues to loop until the user has entered the correct answer. In some embodiments, as well as simply indicating whether the part of the answer is right or wrong, the interactive learning environment can also display messages or guidance or identify the source of further auxiliary learning materials, such as a tutorial on pie charts and percentages. Whether the current answer is right or wrong is displayed at each step of the process and therefore there is no requirement to mark the answer when a final answer has been entered. At any stage in the process, the user can operate button 237 so that the display is updated to illustrate the correct answer. Again after the user has completed the question in the guide me mode of learning, the user can either select to try the question again by returning along line 204 to step 188 or alternatively can proceed to step 186 and select a different question.

If a “show me” learning mode is selected by activating button 237, then a sequence of scenes are displayed to the user, by the user activating the next button, illustrating the correct answer for each step of a method for answering the question. Hence at step 190, processing proceeds to step 220 and the display is updated by showing how to move a first radii in order to make a first section of the pie chart represent 15%. The display can also be updated with explanatory text explaining what is happening. Once the first step in the answer has been displayed, either the user can press a next button in the display portion causing the next scene in the worked example to be displayed to the user. In an alternative embodiment, the next scene in the worked example can be shown without requiring user intervention. Hence the display portion of the user interface is updated to display the correct answer for each step of the method of answering the question until the final answer has been displayed. Then processing proceeds to step 202 at which the user can select to return to the same question and either try the question, be guided through the question or again have the answer to the question be shown to them. Alternatively, the user can proceed to step 186 and select a different question.

Hence, as will be appreciated, owing to the different modes of interaction of the user with the interactive learning environment the user can select to do the same or different questions with different levels of interaction and guidance depending on their understanding of the question and how their understanding of the answer to the questions evolves.

FIG. 12 shows a gap fill type question type in which the user simply needs to enter the final answer to the question displayed in the text box. If the user selects the try question learning mode, then the user can simply type in the final answer, have their answer marked and then proceed to a new question or re-try the question or show the correct answer if their answer is incorrect. If the guide me option is selected then the user is walked through the steps of the answer by displaying different scenes each illustrating a different step in the answer and providing feedback as to whether any answer data entered on any of those screens is correct or not. Hence, in the guide me learning mode, a next scene may display gap fill boxes for the step of converting the time in minutes into the time in seconds. If the user enters incorrect values, then the display is updated to show which of those values are correct or incorrect. A next scene will display gap fill boxes allowing the user to enter the distance value, the speed value and the time value in seconds and again the display can be updated to show if any of those entered data values are correct or incorrect. A final scene can then provide a further gap fill box into which the final answer can be input by the user and again an indication is displayed whether that answer is correct or incorrect. In the show me learning mode, each of the steps of the method of determining the answer to the question is displayed with the correct answer in sequence thereby leading the user through the correct process for answering the question.

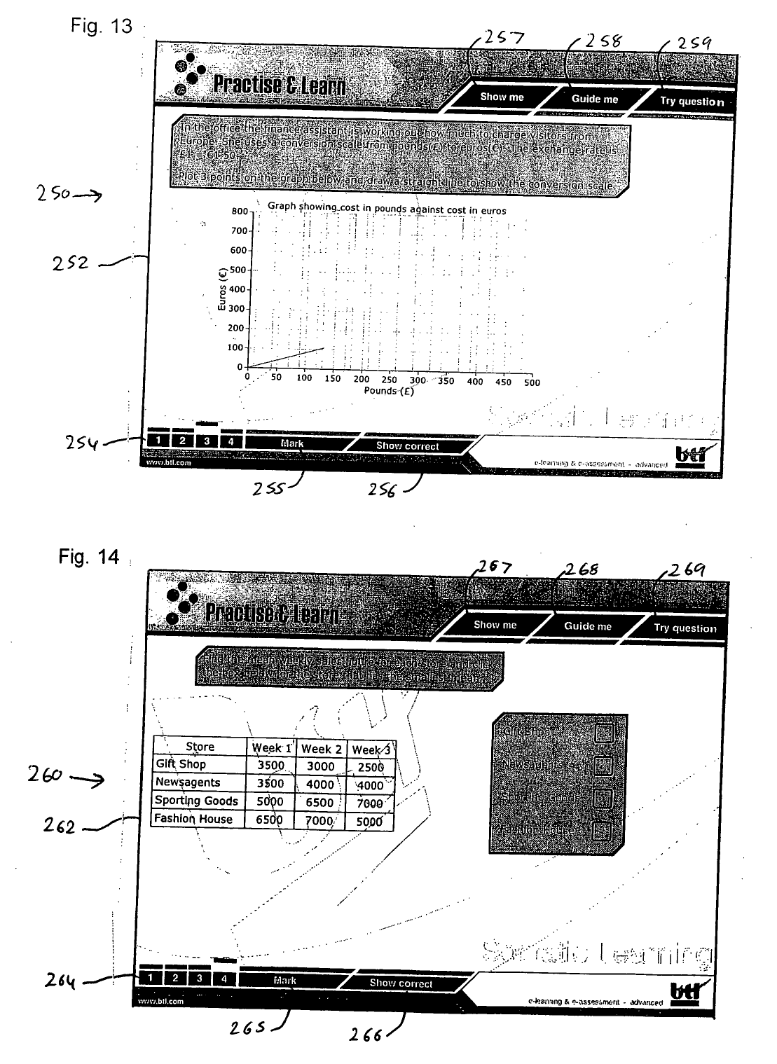

FIG. 13 shows a further graphical type question being displayed in the user interface 250. Again the user can elect to simply try the question and simply identify three points on the displayed graph using a pointer device and draw a straight line and then select to mark the question to determine whether the entered answer is correct or not. In the guide me learning mode, each time the user enters a part of the answer to the question, the display is updated to indicate whether the currently entered part of the answer is correct or not thereby helping to guide the user to the correct answer. In the show me learning mode, each scene shows a next correct step in the method for answering the question thereby explaining to the user the correct method for answering the question.

FIG. 14 shows a further multiple choice type question format being displayed by the user interface 260. The question is set in a text box, a table is displayed providing data on which the question is based and four different answers are provided. In a try question mode of learning, the user simply identifies which answer they believe to be correct and can then determine whether their answer is correct by pressing the mark button 265 causing the display to update to display whether the entered answer is correct or not. In a guide me mode, a sequence of scenes illustrating the steps in calculating the mean value from the display data are displayed in sequence to the user and for each data item entered by the user at each step of answering the question, the display is updated to show whether the entered data item is correct or incorrect thereby helping to guide the user to the correct answer. In a show me learning mode the display is updated to illustrate the correct answer at each stage of calculating the mean value from the data for each of the four scores.

It will be appreciated that the present invention is not limited to any particular subject matter, nor to any particular question format. The question formats illustrated in FIGS. 11 to 14 are by way of example only. Any question format and for any type of subject matter can benefit from the present invention.

It will be appreciated that the present invention allows a user to select the most appropriate way for them to learn depending on their current learning requirements. For new subject matter, the show me mode of learning can initially be used in order to understand how to answer the question. The guide me format can then be used to provide interactive assistance in arriving at the correct answer and then the try question learning mode can be used to practise and master the answer method. Hence the user can select how to learn and change their mode of learning depending on their experience and confidence.

Generally, embodiments of the present invention, and in particular the processes involved in authoring interactive content and displaying and using the interactive learning environment, employ various processes involving data stored in or transferred through one or more computer systems. Embodiments of the present invention also relate to an apparatus for performing these operations. This apparatus may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method steps. A particular structure for a variety of these machines will appear from the description given below.

In addition, embodiments of the present invention relate to computer readable media or computer program products that include program instructions and/or data (including data structures) for performing various computer-implemented operations. Examples of computer-readable media include, but are not limited to, magnetic media such as hard disks, floppy disks, and magnetic tape; optical media such as CD-ROM disks; magneto-optical media; semiconductor memory devices, and hardware devices that are specially configured to store and perform program instructions, such as read-only memory devices (ROM) and random access memory (RAM). The data and program instructions of this invention may also be embodied on a carrier wave or other transport medium. Examples of program instructions include both machine code, such as produced by a compiler, and files containing higher level code that may be executed by the computer using an interpreter.

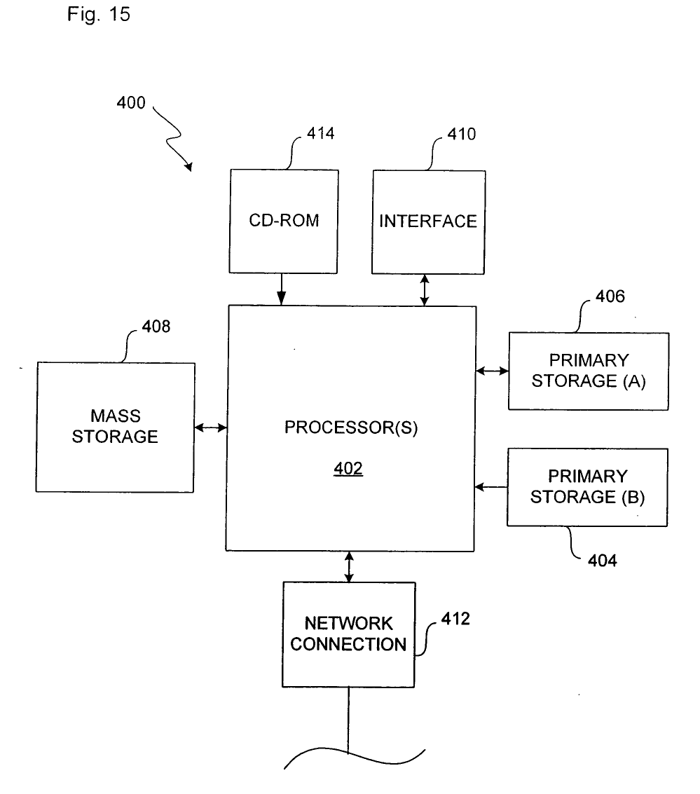

FIG. 15 illustrates a typical computer system that, when appropriately configured or designed, can serve as either an authoring computer or can provide the interactive learning environment of this invention. The computer system 400 includes any number of processors 402 (also referred to as central processing units, or CPUs) that are coupled to storage devices including primary storage 406 (typically a random access memory, or RAM), primary storage 404 (typically a read only memory, or ROM). CPU 402 may be of various types including microcontrollers and microprocessors such as programmable devices (e.g., CPLDs and FPGAs) and unprogrammable devices such as gate array ASICs or general purpose microprocessors. As is well known in the art, primary storage 404 acts to transfer data and instructions uni-directionally to the CPU and primary storage 406 is used typically to transfer data and instructions in a bi-directional manner. Both of these primary storage devices may include any suitable computer-readable media such as those described above. A mass storage device 408 is also coupled bi-directionally to CPU 402 and provides additional data storage capacity and may include any of the computer-readable media described above. Mass storage device 408 may be used to store programs, data and the like and is typically a secondary storage medium such as a hard disk. It will be appreciated that the information retained within the mass storage device 408, may, in appropriate cases, be incorporated in standard fashion as part of primary storage 406 as virtual memory. A specific mass storage device such as a CD-ROM 414 may also pass data uni-directionally to the CPU.

CPU 402 is also coupled to an interface 410 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 402 optionally may be coupled to an external device such as a database or a computer or telecommunications network using an external connection as shown generally at 412. With such a connection, it is contemplated that the CPU might receive information from the network, or might output information to the network in the course of performing the method steps described herein.

Although the above has generally described the present invention according to specific processes and apparatus, the present invention has a much broader range of applicability. In particular, aspects of the present invention is not limited to any particular subject matter, or to any particular type of questions. Rather, the invention can be of utility in learning any kind of subject matter in which a question and answer format can be of benefit in helping to learn and understand the subject matter area. One of ordinary skill in the art would recognize other variants, modifications and alternatives in light of the foregoing discussion.

Further, the invention is not necessarily limited to the specific structures and functions depicted in the drawings, which are by way of general illustration of the principles of the invention only. For example, unless the context requires otherwise, the invention is not limited to the specific data processing operations depicted in the flow charts which are merely schematic. The various steps of the data processing operations may be varied, for example by being broken down into a larger number of sub-processes or being combined into more general processes, and, unless required, the order and timing of the operations may be varied.

The many features and advantages of the present invention are apparent from the written description and it is intended by the appended claims to cover all such features and advantages of the invention. Further, since numerous modifications and changes will readily occur to those skilled in the art, the invention should not be limited to the exact construction and operation as illustrated and described. Hence all suitable modifications and equivalents may be considered to fall within the scope of the invention.

1. A computer implemented interactive learning method, the method comprising:
displaying a question which can be answered by a user;
receiving a user command selecting to answer the question directly, to be guided through the steps of a method of answering the question or to have the steps of the method of answering the question shown to the user; and
if the user has selected to answer the question directly, then:
receiving answer data input by the user including a final answer;
determining whether the final answer corresponds to the correct answer to the question; and
displaying an indication whether the final answer is correct;
if the user has selected to be guided through the steps of the method of answering the question, then:
receiving user answer data input by the user;
determining whether current answer data for a current step of the method is correct; and
displaying an indication whether the current answer data is correct;
if the user has selected to have the steps of the method of answering the question shown, then:
for each step in the method of answering the question:
displaying current answer data illustrating the correct answer for each step of the method of answering the question.

2. The method as claimed in claim 1, wherein the question is displayed in a user interface and the user interface comprises a question display portion in which the question is displayed and a control section including a control element which can be activated to select trying to answer the question directly, be guided through answering the question and being shown steps of the method of answering the question.

3. The method as claimed in claim 1, wherein the user interface includes a further control element which can be activated to display an indication whether answer data is correct.

4. The method as claimed in claim 1, wherein the user interface includes a further control element which can be activated to display the correct answer.

5. The method as claimed in claim 1, wherein the steps in the method of answering the question are displayed by calling a sequence of scenes and wherein the next scene to display in the sequence is determined by a user input.

6. The method as claimed in claim 5, wherein each scene is rendered from data items in a file specifying the content of the scene and the appearance of the scene.

7. The method as claimed in claim 6, wherein the file includes a mark up language defining part of the content of the scene and appearance of the scene and a media file to be used as a part of the scene.

8. A method for authoring interactive questions to be used by a user in an interactive electronic learning environment, the method comprising:
generating a file of data items specifying the content and appearance of a plurality of scenes for an interactive question, each scene displaying a step in a method of answering the question, and data items specifying which scene to display next in a sequence of scenes dependent on user input; and
providing a viewing engine associated with the file for displaying a sequence of scenes to the user, wherein the specific sequence of scenes displayed depends on the user input.

9. The method as claimed in claim 8, wherein the file of data items includes mark up language instructions defining the content and appearance of each scene and also a media file to be used in the scene.

10. The method as claimed in claim 8, wherein the file further includes:
a reading engine for generating the scenes to be displayed from the data items; and
a navigation engine which controls what scene to display next based on user input.

11. A method for providing an electronic interactive learning environment allowing a user to select how to do a plurality of questions, the method comprising:
reading a file including data items specifying the content and appearance of a plurality of scenes for each of a plurality of interactive questions, each scene displaying a step in a method of answering the question, and data items specifying which scene to display next in a sequence of scenes dependent on user input and displaying a scene for a currently selected question;
receiving user input selecting a manner in which to do the currently selected question; and
displaying a sequence of scenes for the question, wherein the sequence of scenes allows the user to do the question in the manner selected by the user.

12. A user interface for an interactive electronic learning environment, the user interface including:
a question display portion for displaying a plurality of scenes relating to questions and steps of methods of answering questions;
a first control element selectable by a user to answer a displayed question directly;
a second control element selectable by a user to be guided through at least some of the steps of a method of answering a displayed question; and
a third control element selectable by a user to be shown at least some of the correct steps of a method of answering a displayed question.

13. A data processing apparatus for providing an interactive electronic learning environment including a plurality of questions which can be displayed to a user and used by the user to interactively learn, the apparatus comprising a data processor configured by computer program code to:
display a question which can be answered by a user;
receive a user command selecting to answer the question directly, to be guided through the steps of a method of answering the question or to have the steps of the method of answering the question shown to the user; and
if the user selects to answer the question directly, then:
receive answer data input by the user including a final answer;
determine whether the final answer corresponds to the correct answer to the question; and
display an indication whether the final answer is correct;
if the user selects to be guided through the steps of the method of answering the question, then:
receive user answer data input by the user;
determine whether current answer data for a current step of the method is correct; and
display an indication whether the current answer data is correct;
if the user selects to have the steps of the method of answering the question shown, then:
for each step in the method of answering the question:
display current answer data illustrating the correct answer for each step of the method of answering the question.

14. A data processing apparatus for authoring interactive questions to be used by a user in an interactive electronic learning environment, the apparatus including a data processor configured by computer program code to:
create a file of data items specifying the content and appearance of a plurality of scenes for an interactive question, each scene displaying a step in a method of answering the question, and data items specifying which scene to display next in a sequence of scenes dependent on user input; and
provide a viewing engine associated with the file for displaying a sequence of scenes to the user, wherein the specific sequence of scenes displayed depends on the user input.

15. An electronic interactive leaning product comprising a computer readable medium bearing computer program code executable by a data processor, the computer program code including instructions and data specifying the content and appearance of a plurality of scenes for an interactive question, each scene displaying a step in a method of answering the question, and which scene to display next in a sequence of scenes dependent on user input.

16. The product of claim 14, further comprising instructions providing a viewing engine for creating a user interface including a question display portion in which the scenes can be displayed to a user and at least a first control element allowing the user to select a manner in which to do the question.

17. A computer program product comprising a computer readable medium bearing computer program code comprising instructions which can be executed by a data processing device to:
display a question which can be answered by a user;
receive a user command selecting to answer the question directly, to be guided through the steps of a method of answering the question or to have the steps of the method of answering the question shown to the user; and
if the user has selected to answer the question directly, then:
receive answer data input by the user including a final answer;
determine whether the final answer corresponds to the correct answer to the question; and
display an indication whether the final answer is correct;
if the user has selected to be guided through the steps of the method of answering the question, then:
receive user answer data input by the user;
determine whether current answer data for a current step of the method is correct; and
display an indication whether the current answer data is correct;
if the user has selected to have the steps of the method of answering the question shown, then:
for each step in the method of answering the question:
display current answer data illustrating the correct answer for each step of the method of answering the question.

18. An interactive computer implemented learning method for allowing a user to learn from a question in a best current learning mode for the user, comprising:
displaying a question to a user;
receiving a command from the user to select a learning mode from a plurality of different learning modes each providing a different level of assistance to the user in answering the question; and
allowing the user to work through the question in the selected learning mode.
